(19) United States
(12) Patent Application Publication
(10) Pub. No.: US 2005/0088118 A1
(43) Pub. Date: Apr. 28, 2005

(54) Light string repair devices

(76) Inventor: Frank Joseph Prineppi, Freeport (BS)

Correspondence Address: FRANK J. PRINEPPI, PMB 341, 1323 S.E. 17th ST, FT. LAUDERDALE, FL, 33316, US

(21) Appl. No.: 10/911,567

(22) Filed: Aug. 5, 2004

(30) Foreign Application Priority Data
Oct. 28, 2003 (GB) 03250565.1

(51) Int. Cl. F21V 21/00; H05B 37/02

(52) U.S. Cl. 315/308

(57) ABSTRACT

According to a first aspect of the invention there is provided an electrically operable sensor (3) for sensing when an excess current is being drawn by a mains powered light string in which one or more light bulbs have failed and the circuit has been repaired via one or more shunts, the sensor (3) thereafter indicating the need to locate and replace the failed bulbs within the string. In accordance with a second aspect of the invention there is provided a light string circuit repair device (7) for generating a relatively high voltage as compared to the operating voltage of the light string in use, wherein switch means (6) are provided to produce only a single burst of current at a relatively high voltage for a very short duration, whereafter the device (7) becomes deactivated and can only be reactivated upon the switch means (6) being returned to its initial state or condition.

### BACKGROUND OF THE INVENTION

This invention relates to repair devices for light strings used to decorate e.g. Christmas trees, the or each light string comprising a string of series-wired fairy lights powered by mains voltage.

A problem encountered with Christmas light strings is that when a light bulb fails the circuit becomes open and the whole string goes out. A well-known way of overcoming this problem is through the use of shunt devices whereby metal oxide insulating coating is used to insulate a wire shunt connected to the filament support tines in each bulb, such that when the filament fails the full mains voltage breaks down the insulation and causes the shunt wire to fuse to the tines, thereby restoring a permanent connection therebetween to enable the full mains voltage to flow through the whole light string and light up the remaining bulbs. The faulty bulb may thereafter be removed, although when the light string consists of a large number of bulbs, typically fifty, it will be understood that the presence of a faulty bulb in the string may not be noticed.

Where, however, the light string has two or more faulty bulbs, perhaps following storage over a long period, thereby allowing bulbs to fail due to the ingress of air, or due to mechanical shock during such storage, such circuit repair devices will not automatically activate and repair the light string when powered by mains electricity. This is because there are now two or more open circuits and so the full mains power, which may be 110 volts or 220 volts, depending upon the country concerned, is not available for fusing the oxide coating on each faulty bulb shunt wire, i.e. the voltage is shared between the two or more faulty bulbs. To overcome this problem it is known to use mains operated shunt “repair” devices which momentarily apply a high voltage to the light string, such as in excess of 400 volts where the light string main voltage is 110 volts, to thereby fuse the shunt wires in the faulty bulbs to thereafter allow the remaining bulbs to light. In doing so, it will be appreciated that the remaining bulbs burn more brightly because they share the extra voltage which would otherwise go to the faulty bulbs, and in doing so they also heat up. Whilst this is not particularly problematic when just a few of the bulbs of a light string consisting of many bulbs become faulty, it will be appreciated that as more of the remaining bulbs begin to overheat and burn out, more shunts are then activated. If this is allowed to continue the string can go into a runaway or “cascade” condition whereby eventually the last bulb to fail, even if it is designed to operate at only about 2.2 volts, nevertheless has e.g. a full 110 volts across it. As will be further appreciated, a progressively increasing fire hazard therefore arises with a light string with several or many faulty bulbs and given the surroundings in which such light strings are situated, typically being strung around and on the branches of a Christmas tree, it will be appreciated that very serious consequences are likely in the event of the light string overheating or even catching fire.

The present invention is derived from the realisation that there is a need for a user friendly device for sensing when there is too much mains current being drawn by a light string due to a number of bulbs having become faulty and their shunts activated or “repaired”, to the extent that a safe limit of failed and subsequently shunted bulbs has been reached.

### SUMMARY OF THE INVENTION

According to a first aspect of the invention there is provided an electrically operable sensor for sensing when an excess current is being drawn by a mains powered light string in which one or more light bulbs have failed and the circuit has been repaired via one or more shunts, the sensor thereafter indicating the need to locate and replace the failed bulbs within the string.

Conveniently, the sensor may be incorporated in a light string circuit testing and repair device such as one in which a relatively high voltage can be applied to the string as compared to its operating voltage to thereby fuse shunt wires of faulty bulbs and hence repair the circuit.

In accordance with a second aspect of the invention there is provided a light string circuit repair device for generating a relatively high voltage as compared to the operating voltage of the light string in use, wherein switch means are provided to produce only a single burst of current at a relatively high voltage for a very short duration, whereafter the device becomes deactivated and can only be reactivated upon the switch means being returned to its initial state or condition.

The invention will now be described, by way of example only, with reference to the accompanying drawings in which:

### BRIEF DESCRIPTION OF THE DRAWINGS

FIG. 1 shows a circuit for a sensor in accordance with the first aspect of the invention,

FIG. 2 shows a circuit for a sensor according to a second embodiment of the invention in its first aspect,

FIG. 3 shows a circuit for a sensor according to a third embodiment of the invention in its first aspect,

FIG. 4 shows a circuit for a sensor according to a fourth embodiment of the invention in its first aspect, and

FIG. 5 shows a switch arrangement for use in the second aspect of the invention.

### DETAILED DESCRIPTION OF THE DRAWINGS

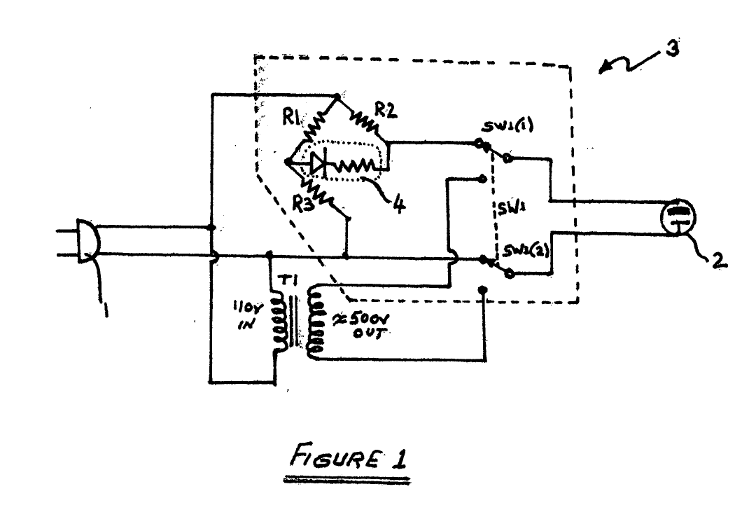

Referring firstly to FIG. 1, there is shown a circuit for use in a light string shunt repair device which also includes a sensor for sensing when an overload (overcurrent) condition exists in a light string (not shown) under repair. The light string shunt “repair” device itself is conventional and comprises a mains plug 1, a transformer T1 for stepping up e.g. 110 volts input to a 500 volts output to a socket 2 into which may be plugged the corresponding mains plug (not shown) of a light string. As discussed previously, the general operation of the light string repair device is to provide a relatively high voltage, in this case 500 volts, to a light string where two or more bulbs having shunts have failed. Light string testing and repair devices of this general configuration are well-known and an example is that made by Roman, Inc and sold as item number 161255. However, in accordance with a first aspect of the invention a sensor means is provided to detect an overload condition in an otherwise operable light string by means of a test circuit shown generally at 3. This comprises a double pole slide switch SWI having poles SWI/1 and SWI/2 by which the output from transformer T1 can be selectively turned off and, in the position shown, the socket 2 directly connected to the mains by the plug 1 via the rest of the sensor circuit 3. In this embodiment, a Wheatstone bridge comprised of resistors R1, R2 and R3 senses the current or load (RL) in the light string and a Light Emitting Diode (LED) 4 is used to indicate when an overload condition exists.

As will be appreciated, the ratio of R1/R3 and R2/RL determines the voltage at the terminals of the LED 4 and if the current goes beyond a pre-set value, the voltage at the LED 4 turns it on. If the current in the load RL is below the pre-set value the LED 4, being a one-way device, is not turned on. Hence, an overload condition in RL ensures that the LED 4 is turned on, thereby indicating that the operator of the device should thereafter investigate the light string and replace all faulty bulbs.

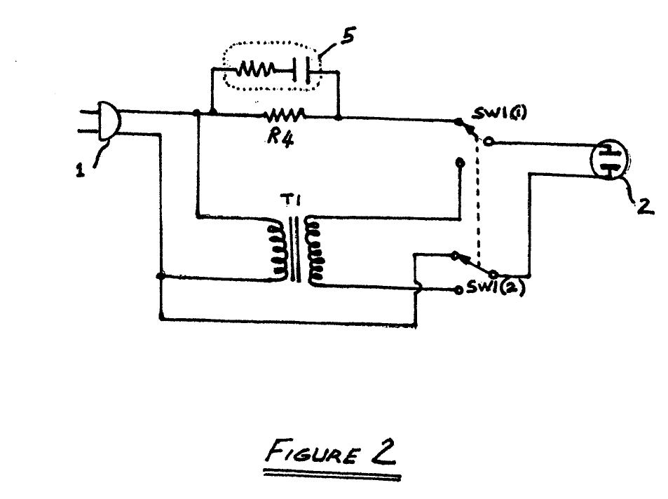

FIG. 2 shows a simplified version of the arrangement of FIG. 1 where like parts are identified the same. In this arrangement, a high wattage series resistor R4 is used such that a voltage will develop across it which will turn on the LED 5 when an overload condition exists.

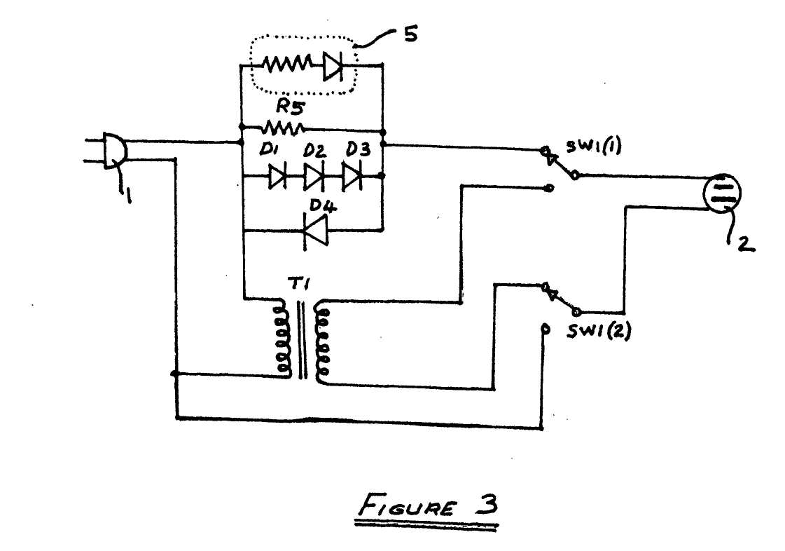

FIG. 3 is a preferred arrangement where again like parts are numbered the same. In this arrangement the need for a large series resistor is obviated. A low wattage series resistor R5 receives the current and as the LED 5 lights up only on half cycles a diode D4 allows the current from the other half cycle to flow through it, rather than through resistor R5, which would otherwise heat up the latter. Diodes D1, D2 and D3 are used to clamp the voltage that develops across resistor R5 to e.g. 3×0.6 volts, so that LED 5 will not burn out if the current is higher than it is designed to carry.

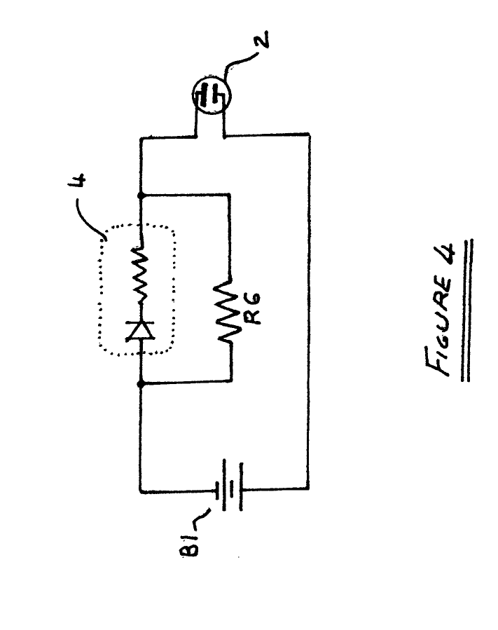

In FIG. 4 there is shown the sensing circuit of a battery operated sensor (not shown), being a stand alone device. Battery B1 supplies current through series resistor R6 and, as before, LED 4 lights up if the voltage across resistor R6 exceeds a pre-set value, thereby indicating an overload condition in a light string connected to the socket 2.

As will be appreciated, although LED's are used in the embodiments described above to indicate when an overload condition exists other such indicating devices could be used including an audible warning or e.g. by the use of a meter type display.

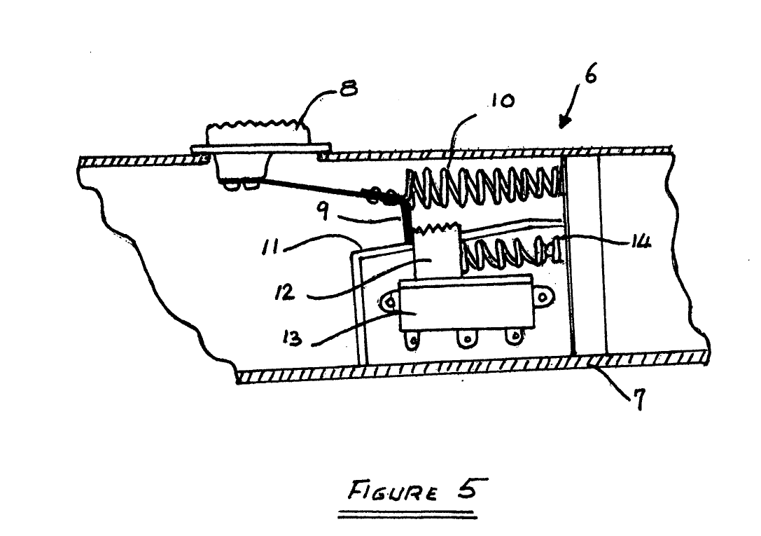

Turning now to FIG. 5, there is shown schematically in section switch means suitable for inclusion in e.g. the body of a handheld shunt repair device for use in accordance with a second aspect of the invention. As will be appreciated, the use of a high voltage generator to “repair” broken filaments in light strings where the bulbs have shunt wires presents intrinsic safety issues and, for instance, the mains operated circuit repair device referred to earlier and sold by Roman, Inc. optionally provides a continuous high voltage current to the light string until the user of the device is satisfied that all of the shunts have been repaired. However, this potential safety hazard is obviated by the switch means in accordance with the present invention shown generally at 6 incorporated within the body 7 of a shunt repair device, only part of which is shown. In this arrangement a sliding button 8 attached to a generally “L”-shaped sprung actuator plate 9 is biased to the rest position as shown by means of a coil spring 10 but is slidable theretowards. The free end of the actuator plate 9 is slidable along a ramp 11 and initially abuts the switch actuator 12 of a slider switch 13, which switch actuator 12 is biased to its off position shown by compression spring 14. By virtue of the actuator 9 being sprung, then as it rides up the ramp 11 it will initially cause the switch actuator 12 to compress the compression spring 14 to eventually actuate the switch 13 and thereafter apply via e.g. the circuit of FIG. 1, to which it may be attached, a high voltage load to socket 2. Briefly thereafter a position is reached whereby the free end actuator 9 becomes clear of the switch actuator 12 which then returns to its closed position via the spring 14. Hence, although the button 8 is able to activate the switch 13 it can only do so momentarily, before the latter is then deactivated, thereby ensuring that there is minimum danger to the user of the device. If it is subsequently found that the single pulse of high voltage current has not “repaired” all of the shunts to thereby complete the light string circuit a further one or several pulses may thereafter be delivered, although on each occasion the switch means ensures that the shunt repair device immediately returns to its original status i.e. off.

1. An electrically operable sensor for sensing when an excess current is being drawn by a mains powered light string in which one or more light bulbs have failed and the circuit has been repaired via one or more shunts, the sensor thereafter indicating the need to locate and replace the failed bulbs within the string.

2. An electrically operable sensor according to claim 1 incorporated in a light string circuit testing and repair device.

3. A light string circuit repair device for generating a relatively high voltage as compared to the operating voltage of the light string in use, wherein switch means are provided to produce only a single burst of current at a relatively high voltage for a very short duration, whereafter the device becomes deactivated and can only be reactivated upon the switch means being returned to its initial state or condition.
